(19) United States
(12) Patent Application Publication
(10) Pub. No.: US 2015/0187374 A1
(43) Pub. Date: Jul. 2, 2015

(54) MANUFACTURING METHOD FOR ROTATING DEVICE

(71) Applicant: Samsung Electro-Mechanics Japan Advanced Technology Co., Ltd., Shizuoka (JP)

(72) Inventors: Yasunori AOKI, Shizuoka (JP); Kefei Wang, Shizuoka (JP); Masayuki Ishikawa, Shizuoka (JP)

(21) Appl. No.: 14/580,910

(22) Filed: Dec. 23, 2014

(30) Foreign Application Priority Data
Dec. 26, 2013 (JP) 2013-269656
Dec. 11, 2014 (JP) 2014-251067

(51) Int. Cl. G11B 5/187

(52) U.S. Cl. CPC G11B 5/187

(57) ABSTRACT

A rotating device includes a hub on which a recording disk is to be mounted and a base that rotatably supports the hub. A manufacturing method for the rotating device includes: a charging and cleaning step including deaerating a hole formed in a workpiece configured as at least one from among the hub and the base; charging a first liquid into the hole, and dipping and cleaning the workpiece in a second liquid in a state in which the first liquid has charged into the hole of the workpiece; and an assembling step for assembling the rotating device using the workpiece after the dipping and cleaning as a component.

### BACKGROUND OF THE INVENTION

1. Field of the Invention

The present invention relates to a manufacturing method for a rotating device.

2. Description of the Related Art

In recent years, by providing a fluid dynamic bearing unit, disk driving apparatuses such as hard disk drives or the like have come to have dramatically improved rotation accuracy. Accompanying this dramatic improvement in the rotation accuracy, there is a demand for such a disk driving apparatus to have higher data density and higher data capacity. In order to configure such a disk driving apparatus with high data density and high data capacity, there is a need to narrow the width of each recording track, and there is a need to narrow the gap between the magnetic head and the recording disk. For example, there is a demand to configure the magnetic head and the recording disk with a very small gap of 10 nm or less between them.

In many cases, a magneto-resistance effect device (which will be referred to an “MR device” hereafter) is employed as a magnetic head so as to provide a disk driving apparatus with high data density. In a case of employing such an MR device, in some cases, such an arrangement has a problem of the occurrence of thermal asperity (which will be “TA failure” hereafter). Here, the mechanism of TA failure is as follows. That is to say, first, the MR device comes in contact with minute foreign substances on the surface of a recording disk during surface tracing of the recording disk by the magnetic head. This provides the minute foreign substances with kinetic energy, leading to instant heat generation in the MR device. Accordingly, the MR device is instantly heated or otherwise cooled, leading to instant variation in the resistance of the MR device. The variation in the resistance is superimposed on a reproduced signal as noise, resulting in reduction in the efficiency of the high-precision readout operation for reading out the reproduced signal. As the gap between the magnetic head and the recording disk becomes narrower, the rate of occurrence of TA failure becomes larger.

As a result of investigation conducted by the present inventors, the present inventors have obtained the mechanism of the occurrence of foreign substances on the surface of a recording disk that can cause TA failure. That is to say, foreign substances each having a size on the order of 0.1 μm to several μm that have adhered to the disk driving apparatus become detached due to vibration or the like. The foreign substances thus detached adhere to the surface of the recording disk due to air flow or the like. Thus, foreign substances that adhere to the disk driving apparatus become a great challenge for providing high data density and high data capacity.

In order to solve such a problem, Japanese Patent Application Laid Open No. 2010-244627, Japanese Patent Application Laid Open No. 2012-50212, Japanese Patent Application Laid Open No. 2013-30235, and Japanese Patent Application Laid Open No. 2013-186913 have disclosed manufacturing methods for a rotating device including a step for cleaning the components of the rotating device.

### SUMMARY OF THE INVENTION

With conventional manufacturing methods, foreign substances that adhere to each component can be reduced, thereby providing an improved level of cleanness. However, in order to provide further improved data capacity to a disk driving apparatus, there is an unceasing demand for providing a further improved level of cleanness. With such conventional cleaning methods, in order to provide an improved level of cleanness, there is no alternative but to increase the cleaning time. This leads to increased manufacturing costs, and leads to a bottleneck in timely manufacturing.

Such a problem is not restricted to a disk drive apparatus. Rather, such a problem can occur in various other kinds of rotating apparatuses.

The present invention has been made in view of such a situation. Accordingly, it is a general purpose of the present invention to provide a manufacturing technique for a rotating device which is capable of reducing foreign substances that adhere to each component thereof while suppressing an increase in the manufacturing time required for the rotating device.

In order to solve the aforementioned problem, a manufacturing method for a rotating device according to an embodiment of the present invention relates to a manufacturing method for a rotating device including a hub on which a recording disk is to be mounted and a base that rotatably supports the hub. The manufacturing method includes: a charging and cleaning step including deaerating a hole formed in a workpiece configured as at least one from among the hub and the base, charging a first liquid into the hole, and dipping and cleaning the workpiece in a second liquid in a state in which the first liquid has charged into the hole of the workpiece; and an assembling step for assembling the rotating device using the workpiece after the dipping and cleaning as a component.

Optional combinations of the aforementioned constituting elements and implementations of the invention in the form of methods, apparatuses, or systems may also be practiced as additional modes of the present invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1A and FIG. 1B are a top view and a side view showing a rotating device according to an embodiment;

FIG. 2 is a cross-sectional view taken along line A-A;

FIG. 3 is a top view of a laminated core shown in FIG. 2;

FIG. 4 is an enlarged cross-sectional view showing an enlargement of a portion around a circular member;

FIG. 5 is an enlarged cross-sectional view showing an enlargement of a portion around a shaft small-diameter portion;

FIG. 6 is a schematic manufacturing flowchart showing a manufacturing method according to the embodiment;

FIG. 7 is a schematic diagram showing a charging and cleaning step and a drying step shown in FIG. 6;

FIGS. 8A and 8B are diagrams each showing a workpiece dipped in a charging liquid; and

FIGS. 9A through 9C are schematic diagrams each showing processing in which ultrasonic waves are applied to a hub via a cleaning liquid.

### DETAILED DESCRIPTION OF THE INVENTION

The invention will now be described by reference to the preferred embodiments. This does not intend to limit the scope of the present invention, but to exemplify the invention.

A rotating device according to an embodiment is suitably employed as a disk driving apparatus, and particularly, as a hard disk drive that mounts a magnetic recording disk and that rotationally drives the magnetic recording disk thus mounted.

First, description will be made regarding the background to the development of an embodiment of the present invention.

A rotating device according to an embodiment includes a rotor on which a magnetic recording disk is to be mounted and a stator that rotatably supports the rotor via a fluid dynamic bearing. Various kinds of holes are provided to each component of the rotor and the stator. For example, a base has a bearing hole into which a bearing unit is to be inserted, screw holes used to fix a top cover to an outer wall portion of the base by screws, screw holes used to fix the rotating device to another device by screws, holes which are each used to arrange a pin or the like such that it stands erect on the base, and the like. Also, the hub has screw holes used to fix a clamper to the hub by screws, for example. In the following description, such holes will be collectively referred to as “workpiece holes”. In some cases, foreign substances adhere to the surface of each workpiece hole, examples of which include chips or dust that occur in machining, or hydrocarbon dust derived or denatured from a cutting agent.

The present inventors have recognized that, in order to provide a further improved level of cleanness, the conventional cleaning methods require a long cleaning time to remove foreign substances that have adhered to the workpiece holes and particularly to the workpiece holes each configured as a non-through hole. That is to say, in a conventional cleaning operation in which each component is simply dipped in a cleaning liquid, it is difficult to purge air from the inner space of each workpiece hole due to surface tension, leading to difficulty in the cleaning liquid charging into the inner space of each workpiece hole. Thus, such a conventional cleaning method requires a long cleaning time to remove foreign substances that have adhered to the workpiece holes. Based on the aforementioned findings, the present inventors have developed a manufacturing method according to the present embodiment.

In the manufacturing method according to the present embodiment, before the cleaning operation, a liquid is charged into the workpiece holes each formed in the corresponding component of the rotating device. Subsequently, each component with the workpiece holes into which the liquid has been charged is cleaned using a cleaning liquid. This allows the cleaning liquid to be penetrated into the inner space of each workpiece hole, thereby cleaning the inner face of each workpiece hole and thereby removing the foreign substances. Thus, such an arrangement requires only a relatively short cleaning time to provide a required cleaning level.

### [Rotating Device]

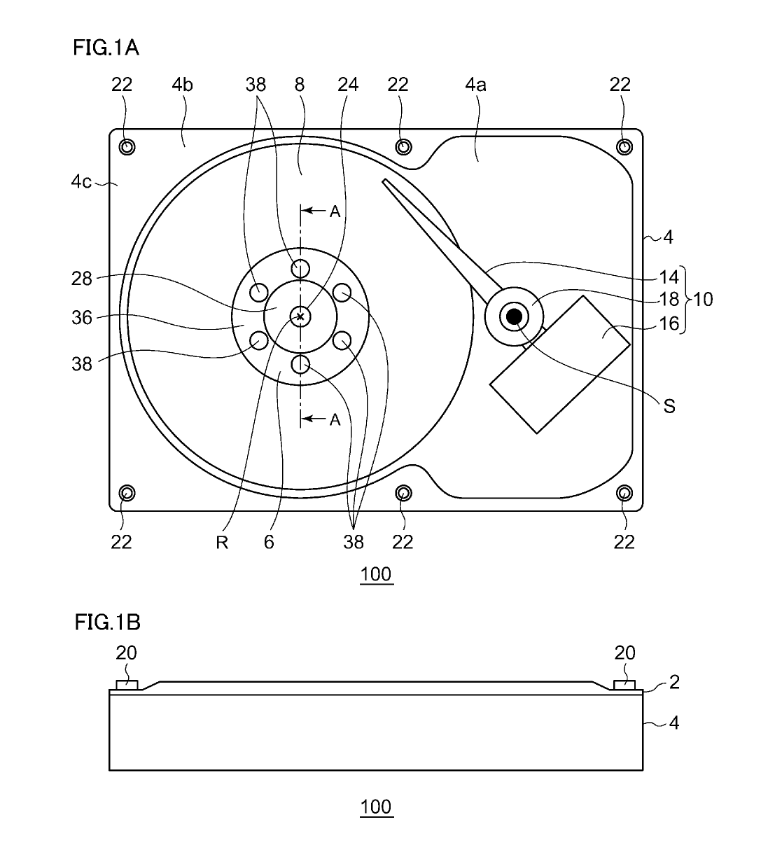

FIGS. 1A and 1B each show a rotating device 100 according to an embodiment. FIG. 1A is a top view of the rotating device 100. FIG. 1B is a side view of the rotating device 100. In order to show the internal structure of the rotating device 100, FIG. 1A shows a state without a top cover 2. The rotating device 100 is configured as a hard disk drive that rotates a magnetic recording disk 8. The rotating device 100 includes a stator, a rotor which rotates with respect to the stator, the magnetic recording disk 8 mounted on the rotor, and a data read/write unit 10. The stator includes a base 4, a top cover 2, and six screws 20. The rotor includes a hub 28, a hub fixation screw 24, a clamper 36, and six clamp screws 38.

Hereinafter, it is assumed that the side of the base 4 on which the hub 28 is mounted is the “upper” side.

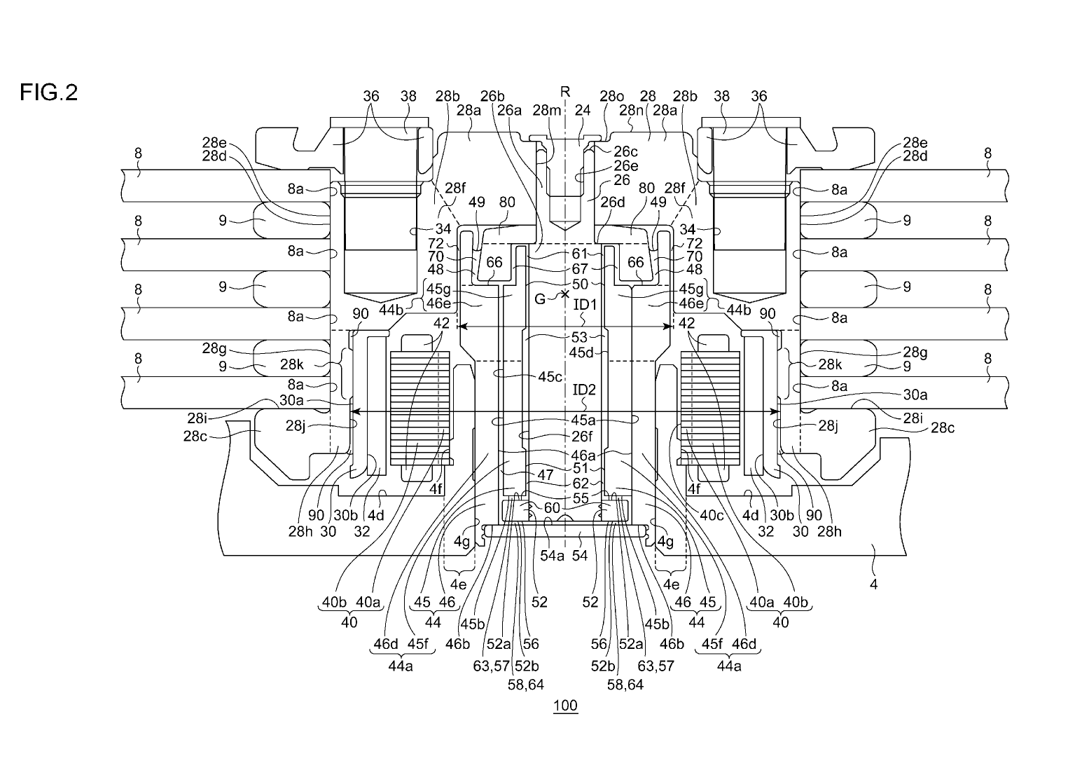

The magnetic recording disk 8 is configured as a 3.5-inch magnetic recording disk formed of an aluminum disk having a diameter of approximately 95 mm, which has a central hole having a diameter of approximately 25 mm, and which has a thickness of approximately 1.27 mm or approximately 1.75 mm. Each magnetic recording disk 8 is mounted on the hub 28, and is rotated according to the rotation of the hub 28. With the present embodiment, four magnetic recording disks 8 are mounted on the hub 28, as described later with reference to FIG. 2.

The base 4 is formed by molding an aluminum alloy material by means of die casting. The base 4 includes a bottom portion 4a that defines the bottom of the rotating device 100, and an outer wall portion 4b formed along the outer edge of the bottom portion 4a so as to surround a mounting region on which the magnetic recording disk 8 is to be mounted. Six screw holes 22 are formed in an upper face 4c of the outer wall portion 4b. Also, the base 4 may be formed by press forming a steel plate or aluminum plate. In this case, the base 4 may be provided with an embossed portion having a structure in which a protrusion is formed on one face of the base 4 by pressing upward, which provides the other face with a recess. By providing such an embossed portion to a predetermined portion of the base 4, such an arrangement is capable of suppressing deformation of the base 4.

In order to prevent the detachment of the surface layer of the base 4, the base 4 is subjected to surface coating. The surface coating may be performed using a resin material such as epoxy resin or the like, for example. Alternatively, the surface coating may be performed by plating the surface of the base 4 with a metal material such as nickel, chrome, or the like. With the present embodiment, the surface of the base 4 is subjected to electroless nickel plating. Such an arrangement allows the surface of the base 4 to have a high hardness and a low friction coefficient, as compared with the surface of the base 4 subjected to resin coating. Furthermore, such an arrangement reduces a risk of damage of the surface of the base 4 or the magnetic recording disk 8 even if the magnetic recording disk 8 comes in contact with the surface of the base 4 in the manufacturing. With the present embodiment, the surface of the base 4 is formed to have a static friction coefficient ranging between 0.1 and 0.6. Such an arrangement further reduces a risk of damage of the base 4 or the magnetic recording disk 8, as compared with the surface of the base 4 having a static friction coefficient of 2 or more.

The data read/write unit 10 includes a record and playback head (not shown), a swing arm 14, a voice coil motor 16, and a pivot assembly 18. The record and playback head is arranged at the end of the swing arm 14, and is configured to record data on the magnetic recording disk 8, and to read out data from the magnetic recording disk 8. The pivot assembly 18 supports the swing arm 14 such that it can be freely swung around the head rotational axis S with respect to the base 4. The voice coil motor 16 swings the swing arm 14 around the head rotational axis S, such that the record and playback head is shifted to a desired position above the face of the magnetic recording disk 8. The voice coil motor 16 and the pivot assembly 18 are each configured using known techniques for controlling the head position.

The top cover 2 is fixedly arranged on the upper face 4c of the outer wall portion 4b of the base 4 using the six screws 20. The six screws 20 respectively correspond to the six screw holes 22. Specifically, the top cover 2 and the upper face 4c of the outer wall portion 4b are fixedly coupled to each other such that no leaks to the interior of the rotating device 100 arise via the connection between them.

FIG. 2 is a cross-sectional view taken along line A-A in FIG. 1A.

The rotor further includes a circular member 80, a magnet 32, a yoke 30, and a flange 52. The stator further includes a shaft surrounding member 44, a stator core 40, a coil 42, and a counter plate 54. The lubricant agent 48 is continuously interposed in a part of the gap between the rotor and the stator.

A shaft 26 is configured such that it extends with the rotational axis R of the hub 28 as its center axis. The shaft 26 has a shaft small-diameter portion 26a in its upper portion, and has a shaft large-diameter portion 26b in its lower portion having a larger diameter than that of the shaft small-diameter portion 26a. A hub fixation screw hole 26e, which is not a through-hole, is formed in the upper face 26c of the shaft small-diameter portion 26a along the rotational axis R. A circular flange 52 is press fitted to the lower end of the shaft large-diameter portion 26b.

The shaft 26 is formed by cutting a steel base material such as SUS420J2 or the like, and by sintering and polishing the resulting member. The sintering of the shaft 26 allows the shaft 26, and particularly the hub fixation screw hole 26e, to have a higher hardness than that of the hub fixation screw 24 to be screwed into the hub fixation screw hole 26e. This reduces the risk of the hub fixation screw 24 biting into the shaft, thereby reducing the risk of deformation of the thread groove provided to the hub fixation screw hole 26e.

The hub 28 is formed by cutting a forged aluminum alloy product such as A6061 or the like, for example. The hub 28 is formed to have a predetermined shape, i.e., an approximately cup-shaped form. In order to prevent the detachment of the surface layer of the hub 28, the hub 28 is subjected to surface coating. The surface coating may be performed using a resin material such as epoxy resin or the like, for example. Also, the surface coating may be performed by plating the surface of the hub 28 with a metal material such as nickel, chrome, or the like, for example. Alternatively, the surface coating may be performed by forming an anodized aluminum layer on the surface. With the present embodiment, the surface of the hub 28 is subjected to electroless nickel plating.

The hub 28 includes a shaft fixation portion 28a which surrounds the upper end side of the shaft small-diameter portion 26a, and which is fixed to the shaft small-diameter portion 26a; a disk fitting portion 28b which is arranged outward from the shaft fixation portion 28a along the radial direction, and which is to be fit to the central hole 8a of each magnetic recording disk 8; and a mounting portion 28c which is arranged outward from the disk fitting portion 28b along the radial direction.

The disk fitting portion 28b is configured to have, as its outer face, an outer cylindrical face 28d which is to be fit to the central hole 8a of each of the four magnetic recording disks 8. The disk fitting portion 28b includes: a first hub cylindrical portion 28f having an outer face that corresponds to the upper portion 28e of the outer cylindrical face 28d and having a first inner diameter ID1; and a second hub cylindrical portion 28h having an outer face that corresponds to the lower portion 28g of the outer cylindrical face 28d and having a second inner diameter ID2 which is greater than the first inner diameter ID1.

Each magnetic recording disk 8 is mounted on a disk mounting face 28i configured as an upper face of the mounting portion 28c. A circular spacer 9 is inserted into a gap between two magnetic recording disks 8 adjacent to each other in the axial direction. The clamper 36 is arranged to press the four magnetic recording disks 8 and the three spacers 9 into contact with the disk mounting face 28i, thereby fixing them on the disk mounting face 28i. The clamper 36 is fixed to the hub 28 by means of six clamper screws 38 screwed into six clamp screw holes 34 formed in the disk fitting portion 28b.

The yoke 30 has a reversed-L-shaped cross-section. The yoke 30 is formed of a magnetic material such as iron or the like. The yoke 30 is fixed to the inner face 28j of the second hub cylindrical portion 28h by means of a combination of adhesion and press fitting. A protrusion 28k is formed on the inner face 28j of the second hub cylindrical portion 28h. In the step in which the yoke 30 is press fitted, the yoke 30 is pressed into contact with the protrusion 28k. The protrusion 28k is configured as a ring-shaped protrusion with the rotational axis R as its center axis. The gap between the inner face 28j of the second hub cylindrical portion 28h and the outer face 30a of the yoke 30 is filled with an adhesive agent 90. This step can be performed by applying a suitable amount of the adhesive agent 90 to the inner face 28j of the second hub cylindrical portion 28h before the yoke 30 is press fitted to the hub 28.

The magnet 32 is configured as a cylindrical member which is fixedly bonded to the inner face 30b of the yoke 30. The magnet 32 is formed of rare earth magnet materials or ferrite magnet materials, for example. With the present embodiment, the magnet 32 is formed of neodymium rare earth magnet materials. The magnet 32 is arranged such that it faces twelve salient poles provided to the stator core 40 in the radial direction. The magnet 32 is configured such that eight driving magnetic poles are formed in the circumferential direction (i.e., in a tangential direction of a circle, the center of which being in the rotational axis R and the circle being perpendicular to the rotational axis R). The magnet 32 is subjected to anti-corrosion surface processing by means of electro-coating, spray coating, or the like.

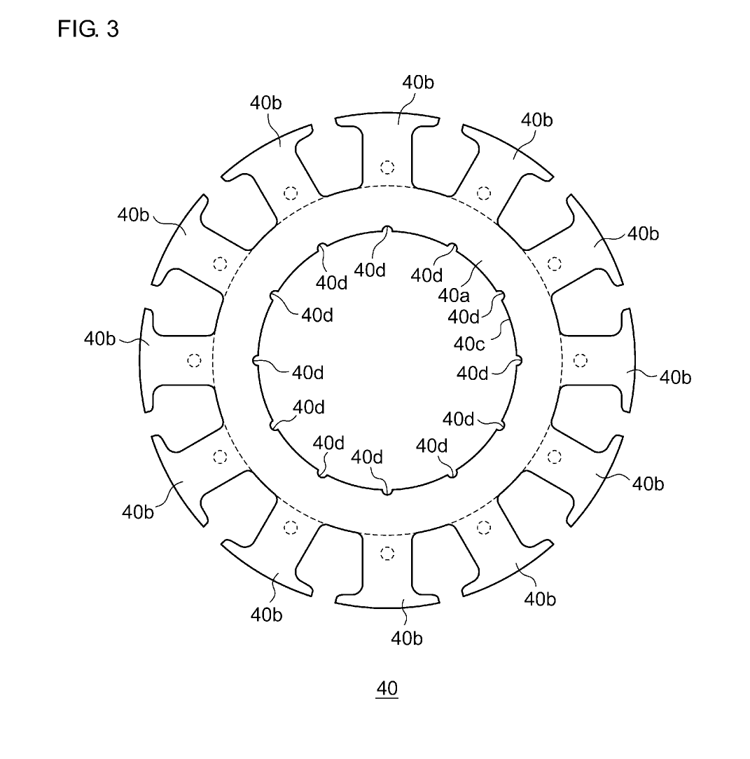

FIG. 3 is a top view of the stator core 40. The stator core 40 has a circular ring portion 40a and twelve salient poles 40b, each protruding from the circular ring portion 40a toward the outer side along the radial direction, and is fixed on the upper face 4d side of the base 4. The stator core 40 is formed by laminating and swaging eighteen thin magnetic steel sheets each having a thickness of 0.35 mm, so as to form a single member. It should be noted that the stator core 40 may also be formed by laminating two to thirty-two thin magnetic steel sheets each having a thickness of 0.1 mm to 0.8 mm, for example. Electrical insulating coating is applied to the surface of the stator core 40 by means of electro-coating, powder coating, or the like. A coil 42 is wound around each salient pole 40b of the stator core 40. By applying a three-phase driving current having an approximately sinusoidal waveform to the coil 42, such an arrangement is capable of generating a driving magnetic flux along each salient pole 40b of the stator core 40. It should be noted that the stator core 40 may be formed by solidifying magnetic power in the form of a sintered compact, for example.

Grooves 40d are each formed in a straight-line form in the inner face 40c of the circular ring portion 40a at a position such that they correspond to the respective salient poles 40b. Each groove 40d is formed in the form of a recessed portion that passes through the overall length of the circular ring portion 40a along the axial direction. With the present embodiment, twelve grooves 40d are formed at regular intervals along the circumferential direction. This suppresses irregularities in the rotation of the rotor. Returning to FIG. 2, description will be made.

The base 4 includes a cylindrical ring-shaped wall portion 4e with the rotational axis R as its center axis. The ring-shaped wall portion 4e is configured such that it protrudes upward so as to surround the shaft surrounding member 44. The stator core 40 is fixedly bonded to the outer face 4f of the ring-shaped wall portion 4e by press fitting or otherwise by running fitting.

The shaft surrounding member 44 is surrounded by the ring-shaped wall portion 4e. The shaft surrounding member 44 is fit to a through hole 4g provided to the base 4 with the rotational axis R as its center axis. Specifically, the shaft surrounding member 44 is fixed to the through hole 4g by adhesion. A ring-shaped recess 66 is formed on the upper side of the shaft surrounding member 44 with the rotational axis R as its center axis. The recess 66 is configured such that it is recessed downward. A communicating hole 47 is formed in the shaft surrounding member 44 such that the upper side and the lower side communicate with each other.

The shaft surrounding member 44 includes a cylindrical inner member 45 which surrounds the shaft large-diameter portion 26b, and a cylindrical outer member 46 which surrounds the inner member 45. The inner member 45 and the outer member 46 are configured as separate members. The inner member 45 surrounds the shaft large-diameter portion 26b via a cylindrical radial gap 53. The outer face 45a of the inner member 45 is fixed to the inner face 46a of the outer member 46 by press fitting. The outer member 46 is fixed to the through hole 4g by adhesion. The recess 66 is formed as a space between the inner member 45 and the outer member 46.

A communicating groove 45c is formed in a straight-line form in the outer face 45a of the inner member 45. The communicating groove 45c is formed as a recessed portion that passes through the overall length of the inner member 45 along the axial direction. Thus, in a state in which the inner member 45 is fixed to the outer member 46, the communicating hole 47 is defined by the communicating groove 45c and the inner face 46a of the outer member 46. It should be noted that, instead of providing such a communicating groove to the outer face 45a of the inner member 45, such a communicating groove may be provided to the inner face 46a of the outer member 46. Such an arrangement also defines the communicating hole 47.

The lower portion 45f of the inner member 45 and the lower portion 46d of the outer member 46 form a fitting small-diameter portion 44a which is fitted and fixed to the through hole 4g. The upper portion 45g of the inner member 45 and the upper portion 46e of the outer member 46 form a surrounding large-diameter portion 44b which is surrounded by the first hub cylindrical portion 28f. With the outer member 46, the upper portion 46e has a larger diameter than that of the lower portion 46d. In other words, the upper portion 46e has a larger thickness along the radial direction than that of the lower portion 46d. Thus, the surrounding large-diameter portion 44b is configured to have a diameter that is larger than that of the fitting small-diameter portion 44a. The radial gap 72 between the surrounding large-diameter portion 44b and the first hub cylindrical portion 28f functions as a labyrinth with respect to the vapor of a lubricant agent 48 that evaporates from a gas-liquid interface 49. Such an arrangement prevents the lubricant agent 48 gas from reaching the magnetic recording disk 8.

The inner member 45 and the outer member 46 may each be formed of various kinds of metal materials or resin materials. The inner member 45 and the outer member 46 may be formed of the same material or otherwise different materials. For example, the inner member 45 and the outer member 46 may each be formed by cutting a brass base material in a desired form and by nickel plating the resulting member. In this case, the inner member 45 and the outer member 46 have the same linear expansion coefficient. This reduces the risk of the occurrence of a gap between the inner member 45 and the outer member 46 even at a high temperature or otherwise at a low temperature. That is to say, such an arrangement allows the normal-operation temperature range to be widened.

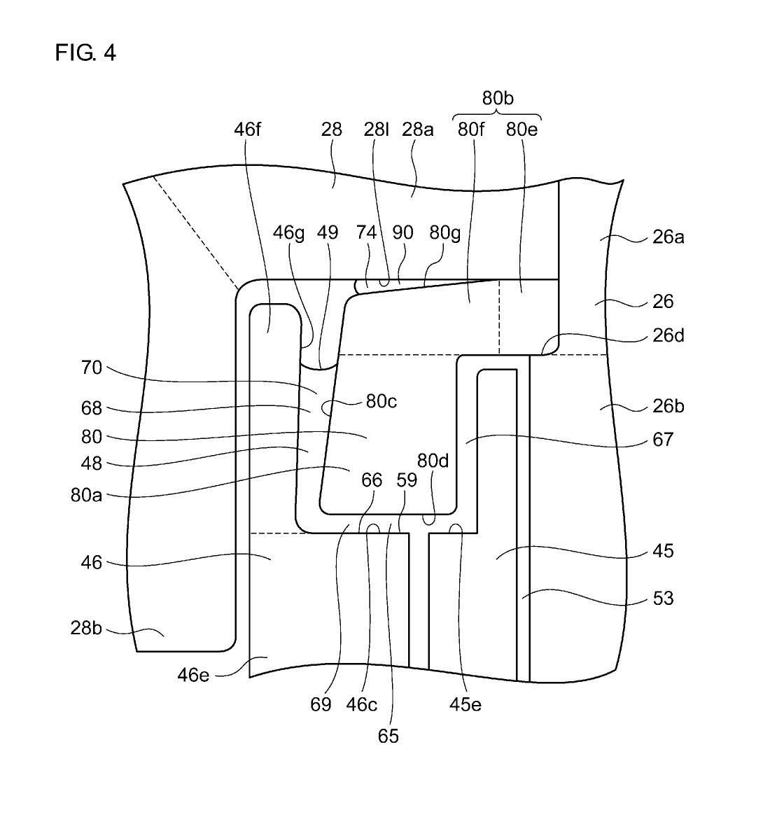

FIG. 4 is an enlarged cross-sectional view showing an enlargement of a portion around the circular member 80. The circular member 80 surrounds and is fixed to the lower end of the shaft small-diameter portion 26a. In this state, the circular member 80 is configured to be rotated together with the shaft 26 and the hub 28 in the form of a single unit. The circular member 80 has a reversed-L-shaped cross-section. The circular member 80 includes an insertion portion 80a which is to be inserted into the recess 66, and an extending portion 80b configured such that it extends inward in the radial direction from the upper end of the insertion portion 80a. The extending portion 80b includes a first extending portion 80e having a circular form, and a second extending portion 80f provided on the outer face side of the first extending portion 80e. The circular member 80 is fixed such that it is interposed between the hub 28 and the shaft large-diameter portion 26b. That is to say, the hub 28 presses the first extending portion 80e in contact with the upper face 26d of the shaft large-diameter portion 26b, thereby fixedly arranging the extending portion 80b. This ensures the precision of the circular member 80 mounting position with respect to the shaft 26. Furthermore, such an arrangement suppresses displacement of the circular member 80 with respect to the shaft 26.

The upper face 80g of the second extending portion 80f is configured as a sloping face with respect to the lower face 28l of the shaft fixation portion 28a. As the position becomes closer to the outer side in the radial direction, a gap 74 between the upper face 80g of the second extending portion 80f and the lower face 28l of the shaft fixation portion 28a becomes greater. The gap 74 functions as an adhesive agent reservoir which reserves the adhesive agent 90 in a step in which the hub 28 is fixed to the shaft 26 by means of a combination of adhesion and press fitting, which will be described later. The adhesive agent 90 thus reserved in the gap 74 also functions as a sealing material which prevents the lubricant agent 48 from leaking out. It should be noted that at least one of the upper face 80g or the lower face 28l may be provided with a recess which functions as an adhesive reservoir. Also, the upper face 80g may be provided with a protrusion which protrudes upward such that it surrounds the shaft small-diameter portion 26a. Such an arrangement prevents the adhesive agent 90 from reaching a tapered sealing portion 70.

After the insertion portion 80a is inserted into the recess 66, a gap is defined by the insertion portion 80a and the recess 66 where they face each other. Specifically, the gap thus defined includes an inner gap 67 and an outer gap 68, each defined by the insertion portion 80a and the recess 66 where they face each other in the radial direction, and an intermediate gap 69 defined by the insertion portion 80a and the recess 66 where they face each other in the axial direction. The outer gap 68 is positioned on the outer side in the radial direction with respect to the inner gap 67. The outer gap 68 has the gas-liquid interface 49.

The intermediate gap 69 includes an agitation portion 65 which generates pressure that directs the lubricant agent 48 toward the inner side in the radial direction when the insertion portion 80a is rotated with respect to the recess 66. A portion of the upper face 46c of the outer member 46 that corresponds to the agitation portion 65 is provided with a groove 59 having a spiral structure or a herringbone structure. Such a groove 59 may be formed in the upper face 45e of the inner member 45, instead of or in addition to providing the groove 59 to the upper face 46c of the outer member 46. Also, such a groove 59 may be formed in the lower face 80d of the insertion portion 80a, instead of or in addition to providing the groove 59 to the upper face 46c of the outer member 46. When the insertion portion 80a is rotated with respect to the recess 66, the groove 59 generates pressure that directs the lubricant agent 48 toward the inner side in the radial direction. The pressure thus generated prevents the lubricant agent 48 from leaking out.

The upper portion 46e of the outer member 46 includes a protrusion 46f arranged such that it faces the insertion portion 80a in the radial direction. The protrusion 46f surrounds the insertion portion 80a. The tapered sealing portion 70 is formed between the protrusion 46f and the insertion portion 80a such that it gradually extends as it approaches the upper side. Specifically, the inner face 46g of the protrusion 46f and the outer face 80c of the insertion portion 80a are each configured such that their diameters become smaller as they approach the upper side. Furthermore, the diameter of the inner face 46g of the protrusion 46f becomes smaller at a rate that is smaller than that with which the diameter of the outer face 80c of the insertion portion 80a becomes smaller. Thus, such an arrangement provides the tapered sealing portion 70 with a tapered shape. When the rotor is rotated, an outward force in the radial direction is applied to the lubricant agent 48 within the tapered sealing portion 70 due to centrifugal force. Because the protrusion 46f is configured such that the inner face 46g has a diameter that is smaller as it approaches the upper side, the force is applied to the lubricant agent 48 such that it is drawn downward. Furthermore, the tapered sealing portion 70 prevents the lubricant agent 48 from leaking out using the capillary action.

The insertion portion 80a and the extending portion 80b of the circular member 80 are formed in the form of a single unit. The circular member 80 may be formed of various kinds of metal materials or resin materials. For example, the circular member 80 may be formed by cutting a steel material such as SUS430 or the like having substantially the same linear expansion coefficient as that of the shaft 26. In this case, such an arrangement suppresses the occurrence of stress due to the difference in the linear expansion coefficient. In particular, such an arrangement suppresses the occurrence of cracks or plastic deformation in the circular member 80 or the shaft small-diameter portion 26a. As a steel material employed for the circular member 80, for example, a stainless steel material manufactured by Dido Steel Co., Ltd. under the trade name DHS1 is preferably employed because it involves a small amount of outgas and the machining is easy. It should be noted that, after the insertion portion 80a and the extending portion 80b are formed as separate units, the insertion portion 80a and the extending portion 80b may be coupled with each other. Returning to FIG. 2, description will be made.

The counter plate 54 is fixed to the lower face 46b of the outer member 46 by adhesion such that it covers the lower side of the shaft surrounding member 44. The upper face 54a of the counter plate 54, the lower face 45b of the inner member 45, and the inner face 46a of the outer member 46 define a flange space 60 which houses the flange 52. The upper face 52a of the flange 52 and the lower face 45b of the inner member 45 are arranged such that they face each other in the axial direction via a first thrust gap 57 having a circular form. Furthermore, the lower face 52b of the flange 52 and the counter plate 54 are arranged such that they face each other in the axial direction via a second thrust gap 58 having a circular form.

A gap defined by the shaft 26, the flange 52, and the circular member 80, which are configured as a part of the rotor, and the inner member 45, the outer member 46, and the counter plate 54, which are configured as a part of the stator, is filled with the lubricant agent 48. Furthermore, the communicating hole 47 is filled with the lubricant agent 48. The lubricant agent 48 contains a fluorescent material. When light such as ultraviolet light is irradiated to the lubricant agent 48, the lubricant agent 48 emits light having a wavelength that is different from the incident light, e.g., blue or green light, due to the interaction between the fluorescent material and the incident light. With such an arrangement in which the lubricant agent 48 includes such a fluorescent material, this allows the liquid surface of the lubricant agent 48 to be monitored in a simpler manner. Furthermore, such an arrangement allows the adhesion or leakage of the lubricant agent 48 to be detected in a simple manner.

The radial gap 53 includes two radial dynamic pressure generating portions 61 and 62 configured to apply radial dynamic pressure to the lubricant agent 48 in the radial direction when the shaft 26 is rotated with respect to the shaft surrounding member 44. The two radial dynamic pressure generating portions 61 and 62 are arranged as separate portions at a predetermined interval along the axial direction. Specifically, the first radial dynamic pressure generating portion 61 is arranged above the second radial dynamic pressure generating portion 62. With such an arrangement, a first radial dynamic pressure generating groove 50 and a second radial dynamic pressure generating groove 51, each having a spiral structure or a herringbone structure, are formed at the respective portions of the inner face 45d of the inner member 45 that correspond to the two radial dynamic pressure generating portions 61 and 62. It should be noted that at least one of the first radial dynamic pressure generating groove 50 and the second radial dynamic pressure generating groove 51 may be formed in the outer face 26f of the shaft large-diameter portion 26b of the shaft 26, instead of the inner face 45d of the inner member 45.

The first thrust gap 57 includes a first thrust dynamic pressure generating portion 63 configured to apply axial dynamic pressure to the lubricant agent 48 when the shaft 26 is rotated with respect to the shaft surrounding member 44. With such an arrangement, a first thrust dynamic pressure generating groove 55 having a spiral structure or a herringbone structure is formed at a portion of the upper face 52a of the flange 52 that corresponds to the first thrust dynamic pressure generating portion 63. Also, the first thrust dynamic pressure generating groove 55 may be formed in the lower face 45b of the inner member 45, instead of the upper face 52a of the flange 52.

The second thrust gap 58 includes a second thrust dynamic pressure generating portion 64 configured to apply axial dynamic pressure to the lubricant agent 48 when the shaft 26 is rotated with respect to the shaft surrounding member 44. With such an arrangement, a second thrust dynamic pressure generating groove 56 having a spiral structure or a herringbone structure is formed at a portion of the lower face 52b of the flange 52 that corresponds to the second thrust dynamic pressure generating portion 64. Also, the second thrust dynamic pressure generating groove 56 may be formed in the upper face 54a of the counter plate 54, instead of the lower face 52b of the flange 52.

When the rotor is rotated relative to the stator, dynamic pressure is applied to the lubricant agent 48 by means of the first radial dynamic pressure generating groove 50, the second radial dynamic pressure generating groove 51, the first thrust dynamic pressure generating groove 55, and the second thrust dynamic pressure generating groove 56. By applying such dynamic pressure thus generated, the rotor is supported in a contactless manner both radially and axially. There is a position relation between the first radial dynamic pressure generating portion 61 and the tapered sealing portion 70. That is to say, the first radial dynamic pressure generating portion 61 and the tapered sealing portion 70 at least partially overlap each other in the axial direction.

With regard to the path of the lubricant agent 48, the upper end of the radial gap 53 defined by the shaft 26 and the inner member 45 communicates with the inner gap 67. Furthermore, the lower end of the radial gap 53 communicates with the flange space 60. The inner gap 67 communicates with the flange space 60 via the communicating hole 47. Thus, both ends of the radial gap 53 configured along the axial direction also communicate with each other via the communicating hole 47 which is configured separately from the radial gap 53.

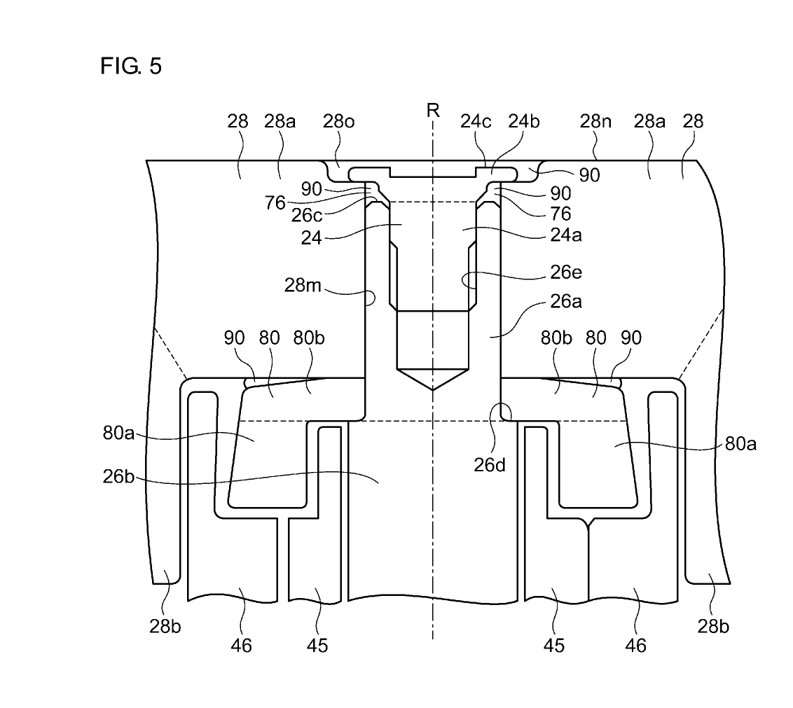

FIG. 5 is an enlarged cross-sectional view showing an enlargement of a portion around the shaft small-diameter portion 26a. The shaft fixation portion 28a of the hub 28 is provided with a shaft hole 28m with the rotational axis R as its center axis. The upper portion of the shaft small-diameter portion 26a is inserted into the shaft hole 28m, and is fixed by means of press fitting and adhesion. Furthermore, the hub 28 is fixed to the shaft 26 by means of the hub fixation screw 24. The hub fixation screw 24 includes a small-diameter portion 24a to be fit to the hub fixation screw hole 26e, and a large-size portion 24b having a size that is larger than that of the small-diameter portion 24a. After the hub fixation screw 24 is screwed into the hub fixation screw hole 26e, the edge of the shaft hole 28m of the hub 28 and the extending portion 80b of the circular member 80 are interposed between the large-size portion 24b of the hub fixation screw 24 and the upper face 26d of the shaft large-diameter portion 26b. That is to say, the hub 28 is fixed between the hub fixation screw 24 and the shaft 26 via the circular member 80. As described above, in addition to adhesion and press fitting, the hub 28 and the shaft 26 are fixed by means of the hub fixation screw 24, and thus they are coupled with sufficient strength.

The upper face 28n of the shaft fixation portion 28a is provided with a hub recessed portion 28o configured such that it is recessed downward. The large-size portion 24b is housed in the hub recessed portion 28o in a state in which the hub 28 is fixed to the shaft 26 after the hub fixation screw 24 has been screwed into the hub fixation screw hole 26e. Specifically, the large-size portion 24b is housed in the hub recessed portion 28o such that its upper face 24c does not protrude upward from the upper face 28n of the shaft fixation portion 28a.

In order to prevent the detachment of the hub fixation screw 24, at least one of the gap between the hub fixation screw 24 and the hub fixation screw hole 26e and the axial gap between the large-size portion 24b and the shaft small-diameter portion 26a (circumferential space 76) may be filled with the adhesive agent 90. For example, in a case in which both gaps are filled with the adhesive agent 90, a suitable amount of the adhesive agent 90 may be applied to the circumferential face of the hub fixation screw hole 26e and the upper face 26c of the shaft small-diameter portion 26a before the hub fixation screw 24 is screwed in, thereby filling both gaps with the adhesive agent 90. Also, the hub recessed portion 28o may be filled with the adhesive agent 90. In this case, the adhesive agent is applied to the hub recessed portion 28o before or otherwise after the hub fixation screw 24 is screwed in, thereby filling the hub recessed portion 28o with the adhesive agent 90. It should be noted that FIG. 5 shows a case in which all the gaps and the hub recessed portion 28o are filled with the adhesive agent 90.

The hub fixation screw 24 may be formed of various kinds of metal materials. For example, the hub fixation screw 24 may be formed by cutting or rolling a steel material such as SUS410 or the like having substantially the same linear expansion coefficient as that of the shaft 26. In this case, such an arrangement suppresses the occurrence of stress due to the difference in the linear expansion coefficient. In particular, such an arrangement suppresses the occurrence of cracks or plastic deformation in the hub fixation screw 24 or the shaft small-diameter portion 26a. Returning to FIG. 2, description will be made.

In a case in which the four magnetic recording disks 8 are mounted on the hub 28, the center of gravity G of the rotor is positioned between the two radial dynamic pressure generating portions 61 and 62 in the axial direction, i.e., is positioned within the bearing span. Typically, as the number of magnetic recording disks 8 mounted on the hub 28 becomes greater, the position of the center of gravity G of the rotor mounting the magnetic recording disks 8 becomes higher (i.e., the center of gravity G shifts upward), and in some cases, the center of gravity G is positioned outside the bearing span. With the present embodiment, mainly by means of the two configurations described below, such an arrangement allows the center of gravity G to be positioned within the bearing span even if the number of magnetic recording disks 8 mounted on the hub 28 is four or more.

Configuration 1: The first radial dynamic pressure generating portion 61 at least partially overlaps the tapered sealing portion 70 in the axial direction. This allows the distance in the axial direction between the first radial dynamic pressure generating portion 61 and the second radial dynamic pressure generating portion 62, i.e., the bearing span, to be increased to that extent without being limited by the length of the tapered sealing portion. That is to say, with the configuration 1, the increased bearing span allows the center of gravity G to be within the bearing span.

Configuration 2: The hub 28 is fixed to the shaft 26 by means of the hub fixation screw 24, in addition to adhesion and press fitting. This allows the hub 28 and the shaft 26 to be connected with each other with sufficient strength without a need to increase the length of the connection portion that connects the hub 28 and the shaft 26 along the axial direction. This allows the shaft fixation portion 28a to be configured to have a relatively small thickness in the axial direction, thereby configuring the upper side of the hub 28 to have a light weight. This provides an advantage of lowering the position of the center of gravity G of the rotor. Furthermore, such a reduction in the thickness of the shaft fixation portion 28a in the axial direction allows the bearing span to be increased. That is to say, the configuration 2 allows the bearing span to be increased while maintaining the center of gravity G at a relatively low level, thereby allowing the center of gravity G to be positioned within the bearing span.

Description will be made regarding the operation of the rotating device 100 thus configured as described above. In order to rotationally drive the magnetic recording disks 8, a three-phase driving current is supplied to the coil 42. When the driving current flows through the coil 42, a magnetic flux occurs along each of the twelve salient poles. The magnetic flux thus generated provides a torque to the magnet 32, thereby rotationally driving the hub 28 and the magnetic recording disks 8 fitted to the hub 28. At the same time, the swing arm 14 is swung by means of the voice coil motor 16, so as to swing back and forth the record and playback head in the swinging range above the magnetic recording disks 8. The record and playback head is configured to convert magnetic data recorded on the magnetic recording disks 8 into an electrical signal, and to transmit the electric signal thus converted to a control board (not shown). Furthermore, the record and playback head receives data transmitted in the form of an electric signal from the control board, and writes the data thus received on the magnetic recording disk 8 in the form of magnetic data.

[Size] The rotating device 100 according to the embodiment may preferably be employed in a so-called 3.5-inch disk drive apparatus, for example. Examples of the size of each gap along the radial direction formed in such a 3.5-inch disk drive apparatus will be listed below.

Inner gap 67: 0.1 mm to 0.2 mm

Outer gap 68: 0.2 mm

Intermediate gap 69: 0.1 mm

Radial gap 53: 3.0 μm to 4.5 μm

Thrust gaps 57 and 58: 20 μm (sum total of the thrust gap sizes)

Gap between the flange 52 and the outer member 46: 0.1 mm or more.

### [Manufacturing Method]

Description will be made regarding a case in which the aforementioned rotating device 100 is manufactured using a manufacturing method according to the present embodiment. The hub 28, the base 4, and other components will collectively referred to as a “workpiece” hereafter.

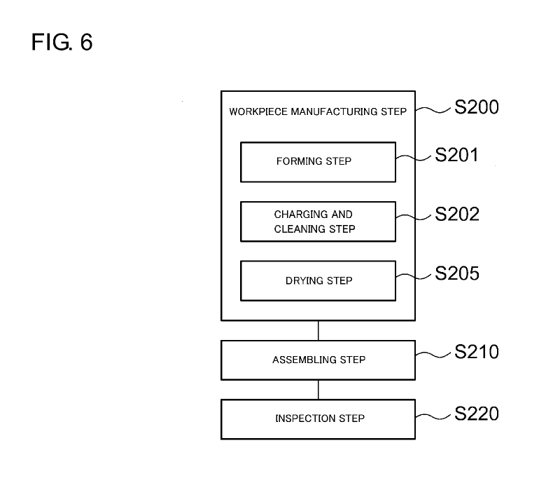

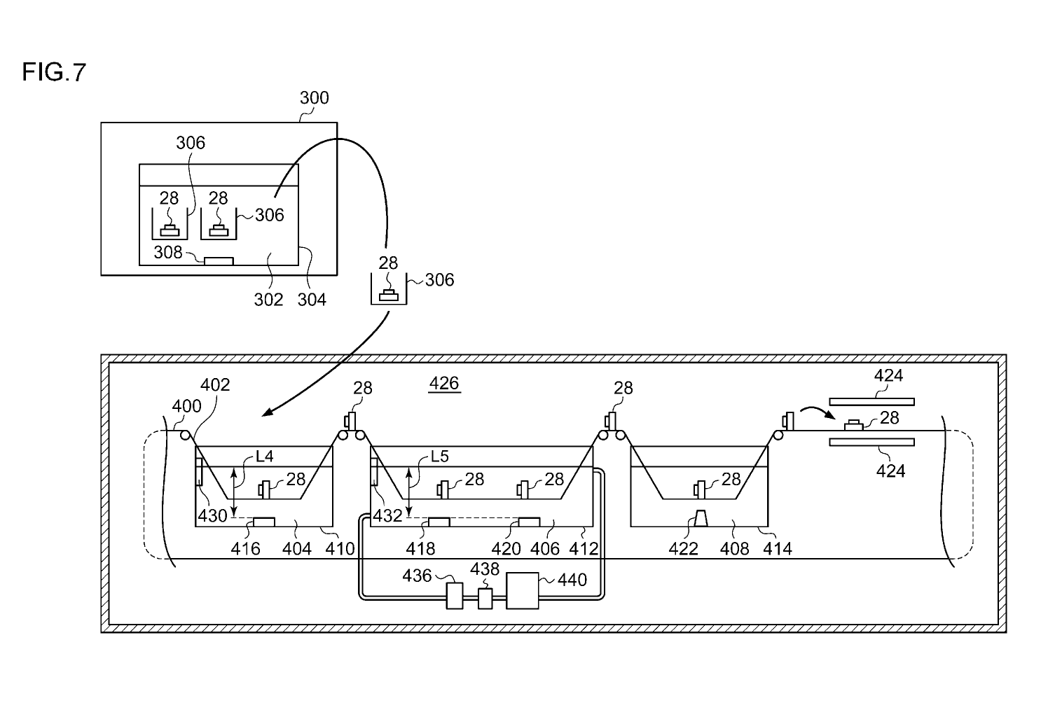

FIG. 6 is a schematic manufacturing process flowchart showing a manufacturing method according to the present embodiment. FIG. 7 is a schematic diagram showing a charging and cleaning step S202 and a drying step S205 included in the workpiece manufacturing step S200. FIG. 7 shows an example in a case in which the workpiece is configured as the hub 28. The manufacturing method according to the embodiment comprises: a workpiece manufacturing step S200 in which the workpiece is manufactured; an assembling step S210 in which the workpiece thus manufactured is assembled; and an inspection step S220 in which the rotating device 100 thus assembled is inspected with respect to its appearance, operation, function, etc. The assembling step S210 includes a step in which the hub 28 is mounted on the base 4, for example. The inspection step S220 includes a step in which the size of the disk mounting portion of the hub 28 is checked with a predetermined portion of the base 4 as a reference, for example. The workpiece manufacturing step S200 includes a forming step S201, the charging and cleaning step S202, and the drying step S205.

In the forming step S201, the workpiece is formed using a manufacturing technique such as forging, casting, machining, or the like. For example, the hub 28 is formed by machining a forged aluminum alloy product such as A6061 or the like, for example. In this step, a cutting agent is used to provide cooling and lubrication. Such a cutting agent contains a large quantity of hydrocarbon. Accordingly, after the hub 28 is formed by machining, a large quantity of hydrocarbon or denatured hydrocarbon adheres to the hub 28. Also, in some cases, chips or dust that occur in machining adhere to the hub 28. That is to say, foreign substances adhere to the hub 28. Such foreign substances also adhere to the inner face of each clamp screw hole 34 configured as a non-through hole formed in the hub 28.

For example, the base 4 is formed by molding and die casting an aluminum alloy material. In this case, hydrocarbon dust or the like derived from grease and oil that have adhered to a die-casting apparatus or a cutting oil used in trimming can migrate to and adhere to the base 4 thus formed. Furthermore, such hydrocarbon dust can adhere to the inner face of each of the six screw holes 22 (see FIG. 1A) each configured as a non-through hole formed in the base 4, the inner face of each hole (not shown), which is used to arrange a pin or the like such that it stands erect on the base 4, and the inner face of each fixation screw hole (not shown in FIGS. 1A and 1B and FIG. 2) which is used to fix the rotating device to another device by screws.

In the charging and cleaning step S202, deaerating and charging processing, bubble removal processing, transporting processing, and cleaning processing are executed. Here, in the deaerating and charging processing, the air within each hole formed in the workpiece is removed, and a liquid is charged into each hole formed in the workpiece. In the bubble removal processing, the bubbles floating in the liquid in which the workpiece is dipped are removed. In the transporting processing, after the liquid has been charged into each hole formed in the workpiece, the workpiece is transported to the cleaning bath. In the cleaning processing, the workpiece thus transported is cleaned. Description will be made regarding each process.

The present inventors have performed various kinds of experiments, and have found that, by applying the following additional conditions to the deaerating and charging processing, such an arrangement allows air to be removed from each hole formed in the workpiece and liquid to be charged into each hole formed in the workpiece in a shorter period of time as compared with a case in which the workpiece is simply dipped in pure water in an atmospheric pressure environment.

(1) Combining, with this processing, imparting vibration to the liquid in which the workpiece is dipped.

(2) Adding a surface tension depressant to the liquid in which the workpiece is dipped, and raising the temperature of the liquid.

In particular, by adding a surface tension depressant to the liquid in which the workpiece is dipped such that the liquid has a surface tension that is lower than that of water (72 mN/m), such an arrangement allows the liquid to be charged into each hole in a short period of time. The surface tension of the liquid is preferably adjusted to be less than half that of the surface tension of water, i.e., less than 36 mN/m, and is more preferably adjusted to be less than that of the surface tension of ethanol (23 mN/m). Such an arrangement allows the liquid to be charged into each hole in a shorter period of time. It should be noted that, from the viewpoint of versatility, in practice the surface tension of the liquid is preferably adjusted in a range that is equal to or greater than 15 mN/m.

Also, by dipping the workpiece in the liquid at a temperature of 25° C. or more, such an arrangement allows the liquid to be charged into each hole in a short period of time, as compared with a case in which the workpiece is dipped in the liquid at a temperature that is lower than 25° C. The temperature of the liquid is preferably set to 35° C. or more, and is more preferably set to 55° C. or more. Such an arrangement allows the liquid to be charged into each hole in a shorter period of time. It should be noted that, from the viewpoint of versatility, in practice the temperature of the liquid is preferably set in a range that is equal to or lower than 65° C.

(3) Adding a fluorochemical surfactant as a component of the surface tension depressant. By adding detergent to the surface tension depressant in addition to the fluorochemical surfactant, such an arrangement allows the liquid to be charged into each hole in a shorter period of time.

(4) Executing this processing in a reduced pressure environment that is lower than atmospheric pressure. In particular, by adjusting the pressure environment to be equal to or lower than 460 torr, such an arrangement allows the liquid to be charged into each hole in a short period of time, as compared with an atmospheric pressure environment. This processing is preferably executed in a pressure environment of 100 torr or less, and is more preferably executed in a pressure environment of 30 torr or less, which allows the liquid to be charged into each hole in a shorter period of time. It should be noted that, from the viewpoint of versatility, in practice the pressure environment is preferably set in a range that is equal to or higher than 15 torr.

(5) Combining, with this processing, an orientation changing operation in which the orientation of the workpiece is changed.

In the deaerating and charging processing, a single condition alone selected from among these conditions may be fulfilled, or otherwise a combination of multiple conditions selected from among these conditions may be fulfilled, so as to complete this processing in a required period of time.

Description will be made below regarding an example in which the deaerating and charging processing is executed with a combination of all the aforementioned conditions.

In the deaerating and charging processing, a decompression chamber 300 is used (see FIG. 7). The deaerating and charging processing may be executed in an atmospheric pressure environment. However, in the present embodiment, the deaerating and charging processing is executed in a reduced-pressure atmosphere environment. By executing the deaerating and charging processing in a reduced-pressure atmosphere environment, such an arrangement allows air remaining in each workpiece hole (e.g., a clamp screw hole 34 formed in the hub 28) to be easily removed, and allows the cleaning liquid to be charged into each workpiece hole in a relatively short period of time. The decompression chamber 300 is configured as an airtight space that allows the removal of air in this internal space by means of an exhaust apparatus (not shown) such as a vacuum pump. This allows the ambient pressure to be reduced to a predetermined pressure. A liquid bath 304, which holds a predetermined quantity of a charging liquid 302, is prepared in the decompression chamber 300. As the charging liquid 302, various kinds of liquids may be used, examples of which include alcohols such as hydrocarbon, IPA, and the like, pure water, and various kinds of aqueous solutions and the like. In the present embodiment, an aqueous solution containing a surface tension depressant is used as the charging liquid 302. Such an aqueous solution has a surface tension that is lower than that of pure water, which allows the charging liquid 302 to be easily charged into each workpiece hole. As such a surface tension depressant, a surfactant may be used.

Examples of such a surfactant that can be used include non-ionic surfactant, cationic surfactant, anionic surfactant, and betaine surfactant. Examples of such a non-ionic surfactant that can be used include silicon surfactant, fluorochemical surfactant, and hydrocarbon surfactant. In the present embodiment, such a fluorochemical surfactant having a high capability for depressing the surface tension is employed. Examples of such a fluorochemical surfactant include perfluoroalkyl sulfonic acid, perfluoroalkyl carboxylic acid and fluorinated telomer alcohols.

In the deaerating and charging processing, a single workpiece is housed in each container 306. Each workpiece is transported together with the container 306 to the liquid bath 304 prepared in the decompression chamber 300, thereby dipping each workpiece in the charging liquid 302. It should be noted that multiple workpieces may be housed in each container. Next, the ambient pressure in the decompression chamber 300 is reduced to a predetermined pressure. When the ambient pressure in the decompression chamber 300 reaches the predetermined pressure, the ambient pressure is rapidly returned to atmospheric pressure. This allows the air to be removed from each workpiece hole, and allows the charging liquid 302 to be charged into each clamp screw hole 34. It should noted that, after a predetermined period of time elapses after the ambient pressure reaches the predetermined pressure, the ambient pressure in the decompression chamber 300 may be returned to atmospheric pressure. That is to say, each workpiece may be held in the charging liquid 302 in a reduced-pressure state during a predetermined period of time.

As a result of the experiments performed by the present inventor, it has been confirmed that, at least in a case in which the workpiece is dipped in the charging liquid 302 having a surface tension of 70 mN/m or less at a temperature of 25° C. or more in a reduced-pressure state in a range of 460 torr or less, required deaerating effects are obtained. That is to say, it has been confirmed that such an arrangement allows the charging liquid 302 to be charged into each clamp screw hole 34 within a practical period of time for processing. Furthermore, it has been confirmed that, in a case in which the workpiece is dipped in the charging liquid 302 having a surface tension of 35 mN/m or less at a temperature of 35° C. or more in a reduced-pressure state in a range of 100 torr or less, such an arrangement provides relatively high bubble removal effects. It should be noted that, in other words, for the conditions of the charging liquid 302, as the temperature of the charging liquid 302 becomes closer to the cloud point in a range in which the charging liquid 302 cannot boil, the bubble removal effect becomes higher.

In the present embodiment, the workpiece is dipped in the charging liquid 302 adjusted such that it has a surface tension ranging between 15 mN/m and 18 mN/m and a temperature ranging between 30° C. and 60° C. in a reduced-pressure state in a range of 260 torr or less. Such an arrangement is capable of absorbing variation of effects.

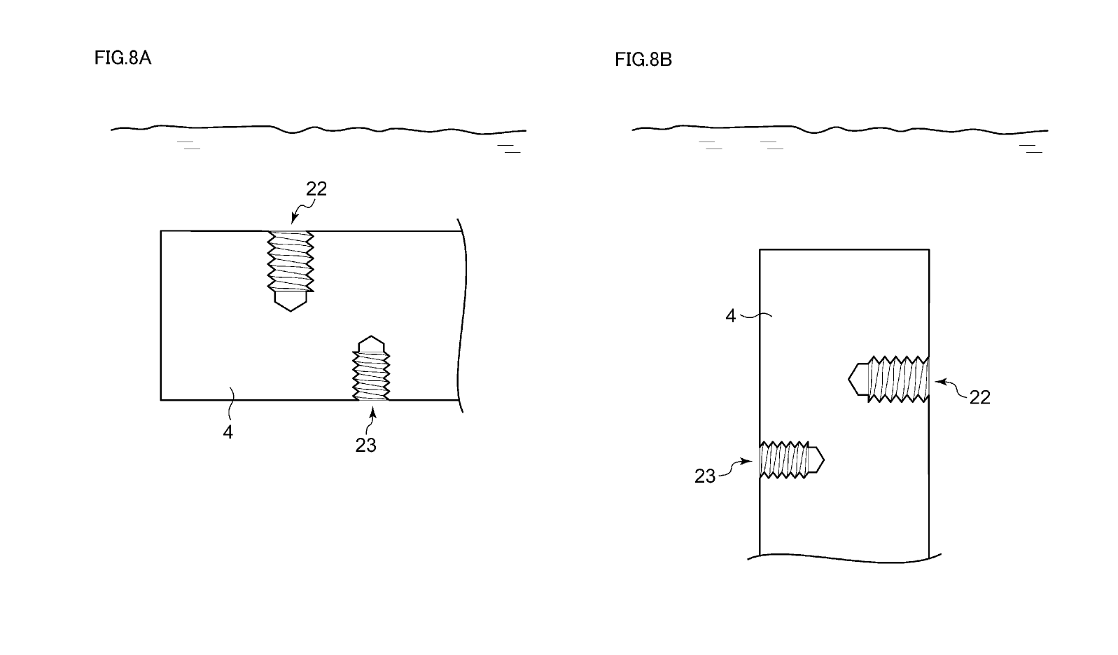

Here, description will be made regarding the orientation of the workpiece in the charging liquid 302. FIGS. 8A and 8B each show the workpiece dipped in the charging liquid 302. FIG. 8A shows the orientation of the workpiece according to the present embodiment. FIG. 8B shows the orientation of the workpiece according to a modification. Description will be made below regarding an example in which the workpiece is configured as the base 4. In FIG. 8A, the base 4 is held with an orientation such that the opening of the screw hole 22 faces upward in the vertical direction. That is to say, with the present embodiment, the workpiece is held with an orientation such that the opening of the workpiece hole into which the charging liquid 302 is to be charged faces upward in the vertical direction. With the orientation shown in FIG. 8A, the air remaining in the screw hole 22 receives buoyancy force upward in the vertical direction. Thus, such an arrangement allows the air remaining in the screw hole 22 to float upward in the charging liquid 302 beyond the screw thread. That is to say, this allows the air remaining in the screw hole 22 to be relatively easily removed. It should be noted that, when the charging liquid 302 is to be charged into a fixation screw hole 23 having an opening that faces in an opposing direction of that of the screw hole 22, the orientation of the workpiece is changed such that the opening of the fixation screw hole 23 faces upward in the vertical direction. This processing will be described later.

In FIG. 8B, the base 4 is held with an orientation such that the opening of the screw hole 22 and the opening of the fixation screw hole 23 each face in the horizontal direction. That is to say, in the present modification, the workpiece is held with an orientation such that at least two workpiece holes having openings that face in approximately opposing directions face each other in the horizontal direction. With the orientation shown in FIG. 8B, such an arrangement allows the air remaining in the screw hole 22 and the air remaining in the fixation screw hole 23 to be removed at the same time. Thus, in a case in which high priority is put on the time required to remove the remaining air, such an orientation condition may be employed.

After the deaerating and charging processing, the vibration processing is executed. In the vibration processing, in order to allow the liquid to be charged into each workpiece hole in a shorter period of time, water flow or vibration is applied to the liquid in which the workpiece is dipped. Examples of such a water flow that can be employed include a vortex flow, traveling-wave flow, and the like. As such vibration, ultrasonic vibration can be employed. Also, detached foreign substances may be filtered and removed in the vibration processing, which suppresses contamination of the cleaning liquid in the subsequent cleaning processing, thereby providing an improved level of cleanness of the workpiece.

In the vibration processing according to the present embodiment, ultrasonic waves are applied to the charging liquid 302 in which the workpiece is dipped in the deaerating and charging processing, thereby applying vibration to the charging liquid 302. For example, in a case in which the workpiece is configured as the hub 28, a first ultrasonic wave generator 308 applies ultrasonic waves having a frequency of 40 kHz to the charging liquid 302 for three to ten minutes. It should be noted that the power density of the ultrasonic waves applied to the cleaning liquid may be adjusted according to the workpiece, i.e., according to the workpiece material.

Because the charging liquid 302 is charged into each workpiece hole, by applying ultrasonic waves to the charging liquid 302 so as to vibrate foreign substances remaining in each workpiece hole, such an arrangement allows foreign substances to be easily detached. It should be noted that the vibration processing may be performed in a reduced-pressure environment. That is to say, in the deaerating and charging processing, the vibration processing may be performed while maintaining the reduced-pressure state after the ambient pressure in the decompression chamber 300 is reduced to a predetermined pressure, instead of applying vibration after the ambient pressure is returned to atmospheric pressure. In a case in which the vibration processing is performed while maintaining the reduced-pressure state, ultrasonic waves can reach each workpiece hole, thereby allowing the air to be removed from each workpiece hole in a surer manner.

In a case in which the workpiece has workpiece holes formed with openings in opposing directions, the orientation changing processing is performed in which the orientation of the workpiece is changed. For example, in a case shown in FIG. 8A, the orientation of the base 4 is changed from the orientation in which the opening of the screw hole 22 faces upward in the vertical direction to the orientation in which the opening of the fixation screw hole 23 faces upward in the vertical direction. In the present embodiment, the orientation of the workpiece is changed in the charging liquid 302 without bringing the workpiece out from the charging liquid 302. After the orientation is changed, the vibration processing is performed again.

After the deaerating and charging processing, check processing may be executed in which a check is performed regarding whether or not the charging liquid 302 has been charged into each workpiece hole. Such an arrangement allows the processing conditions to be adjusted so as to provide a desired charging state even if such a desired charging state has not been obtained. For example, in order to check the charging state, a given workpiece hole of a sampled workpiece may be monitored using a magnifying glass or a microscope. Also, a microscopic endoscope may be inserted into a given workpiece hole so as to monitor the inner face thereof. In the check processing, a computer may be employed to perform automatic judgment. It should be noted that the check processing may be executed after the bubble removable processing.

The air removed from each workpiece hole and the air generated from the charging liquid 302 due to decompression or the application of ultrasonic waves floats on the water surface of the charging liquid 302 in the form of bubbles. In the bubble removal processing, such bubbles are suctioned out by means of a predetermined suction apparatus, thereby removing bubbles, for example. Also, such bubbles may be removed using an overflow method.

In the transport processing, the workpiece is brought out from the liquid bath 304, and is transported into a first cleaning bath 410 (described later). In particular, in the transport processing, the workpiece is brought out together with the charging liquid 302 from the liquid bath 304 using the container 306, and is transported into a first cleaning liquid 404 stored in the first cleaning bath 410 together with the container 306. That is to say, in the transport processing, the workpiece is transported into the first cleaning liquid 404 in a state in which the workpiece is dipped in the charging liquid 302, i.e., without exposing the workpiece to air.

In the cleaning step and the drying step S205, a transport apparatus 400 is used (see FIG. 7). Here, the transport apparatus 400 is configured as a chain conveyer having holders each configured to hold a workpiece. The transport apparatus 400 moves a chain 402 in a clockwise direction, thereby transporting each workpiece together with the corresponding holder (not shown).

In the cleaning processing, the workpiece is cleaned in a clean room 426 in a state in which the charging liquid 302 is charged into each workpiece hole after the deaerating and charging processing. The clean room 426 is filled with clean air. Specifically, the clean room 426 is maintained at a higher level of cleanness than that of the ambient environment in which the deaerating and charging processing is performed. For example, the clean room 426 may be maintained at a level of cleanness on the order of class 1000. The workpiece is transported by means of the transport apparatus 400. In this transporting processing, the workpiece is cleaned using a first cleaning liquid 404, a second cleaning liquid 406, and a third cleaning liquid 408, in this order. In the first cleaning liquid 404 and in the second cleaning liquid 406, the workpiece is cleaned using ultrasonic waves. In the third cleaning liquid 408, the workpiece is cleaned using a water flow. During the cleaning processing, each clamp screw hole 34 is filled with the charging liquid 302 which has been charged in the deaerating and charging processing, or otherwise the first cleaning liquid 404, the second cleaning liquid 406, or the third cleaning liquid 408, with which the charging liquid 302 has been replaced. That is to say, the workpiece is maintained in a state in which a liquid has been charged into each workpiece hole until the drying step S205 in which the workpiece is dried.

A first cleaning liquid 404, a second cleaning liquid 406, and a third cleaning liquid 408 are stored in a first cleaning bath 410, a second cleaning bath 412, and a third cleaning bath 414, respectively. The first cleaning liquid 404 is configured as an aqueous solution containing a surfactant as a main solute. The first cleaning liquid 404 is heated and maintained at a temperature that is higher than room temperature, e.g., at a temperature ranging between 50° C. and 70° C. In a case in which the charging liquid 302 also contains a surfactant, the first cleaning liquid 404 may contain the same kind of surfactant or may contain a different kind of surfactant. The second cleaning liquid 406 is configured as a liquid which can be substantially regarded as pure water. The second cleaning liquid 406 is maintained at a temperature on the order of room temperature, i.e., the second cleaning liquid 406 is not heated. Specifically, the second cleaning liquid 406 is maintained at a temperature ranging between 25° C. and 35° C., for example. The second cleaning liquid 406 is provided with an increased quantity of bubble nuclei by means of a pump 436, a filter 438, and a bubble nuclei increasing unit 440. This provides improved ultrasonic cavitation effects, thereby providing improved cleaning effects. Specifically, the second cleaning liquid 406 is pumped up from the second cleaning bath 412 by means of the pump 436. The second cleaning liquid 406 thus pumped up is filtered by means of the filter 438 such that foreign substances are removed. The second cleaning liquid 406 thus filtered is supplied to the bubble nuclei increasing unit 440. After the second cleaning liquid 406 is supplied with an increased quantity of bubble nuclei by means of the bubble nuclei increasing unit 440, the second cleaning liquid 406 is returned to the second cleaning bath 412. The third cleaning liquid 408 is configured as a liquid which can be substantially regarded as pure water. The third cleaning liquid 408 is heated and maintained at a temperature that is higher than room temperature, e.g., at a temperature ranging between 40° C. and 50° C. By maintaining the third cleaning liquid 408 at a higher temperature than room temperature, such an arrangement provides reduced drying time required for the subsequent drying step S205.

With the present embodiment, the transport apparatus 400 is designed to have a transportation speed such that each workpiece is transported via each cleaning liquid in 5 to 10 minutes. A second ultrasonic wave generator 416 applies ultrasonic waves having a frequency of 40 kHz to the first cleaning liquid 404. A third ultrasonic wave generator 418 and a fourth ultrasonic wave generator 420 apply ultrasonic waves having a frequency of 40 kHz and a frequency of 68 kHz, respectively, to the second cleaning liquid 406. By applying ultrasonic waves having different frequencies by means of the third ultrasonic wave generator 418 and the fourth ultrasonic wave generator 420, such an arrangement generates vibration in the form of an ultrasonic beat. As a result, such an arrangement allows the ultrasonic frequency spectrum to be widened, which reduces cleaning irregularities, thereby providing improved foreign substance removal capability.

Furthermore, in order to improve the cleaning efficiency, the output of the ultrasonic waves and the quantity of the cleaning liquid are adjusted such that the ultrasonic waves have a power density of 10 W/L or more. A first liquid surface adjustment unit 430 and a second liquid surface adjustment unit 432 are used to adjust the quantity of the first cleaning liquid 404 and the second cleaning liquid 406, respectively. Also, the first liquid surface adjustment unit 430 may be used to adjust the distance L4 between the liquid surface of the first cleaning liquid 404 and the second ultrasonic wave generator 416 such that it becomes a multiple of four to ten of the half-wavelength of the ultrasonic waves applied by the second ultrasonic wave generator 416 to the first cleaning liquid 404. Similarly, the second liquid surface adjustment unit 432 may be used to adjust the distance L5 between the liquid surface of the second cleaning liquid 406 and the third ultrasonic wave generator 418, i.e., between the liquid surface of the second cleaning liquid 406 and the fourth ultrasonic wave generator 420.

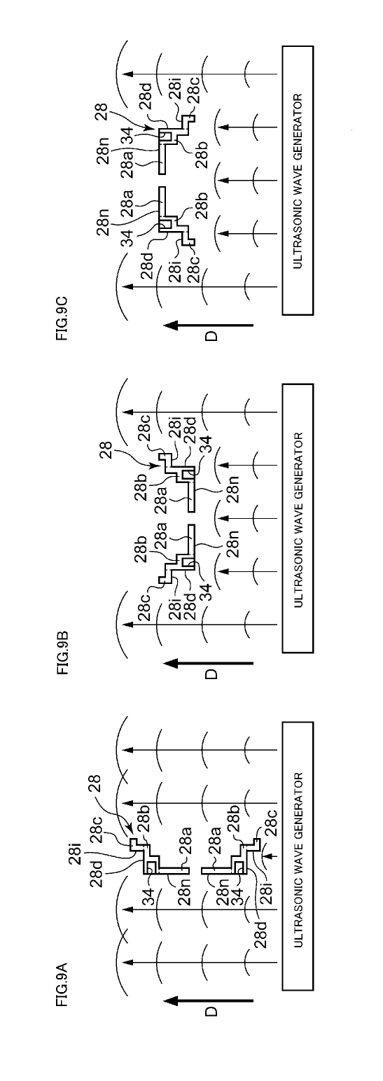

Description will be made below regarding the orientation of the workpiece in the ultrasonic cleaning processing assuming that workpiece is the hub 28. FIGS. 9A through 9C are schematic diagrams each showing the processing in which ultrasonic waves are applied to the hub 28 via a cleaning liquid. FIG. 9A shows the orientation of the hub 28 according to the present embodiment. FIG. 9B shows the orientation of the hub 28 according to a modification. FIG. 9C shows the orientation of the hub 28 according to a comparison example. In FIG. 9A, the hub 28 is held such that the upper face 28n of the shaft fixation portion 28a and the disk mounting face 28i each extend in a direction that is approximately parallel to the ultrasonic wave propagation direction D. In FIG. 9B, the hub 28 is held such that the upper face 28n of the shaft fixation portion 28a and the disk mounting face 28i each extend in a direction that is approximately orthogonal to the ultrasonic wave propagation direction D, and such that the upper face 28n, the clamp screw holes 34, and the disk mounting face 28i each face the ultrasonic wave generator side. In FIG. 9C, the hub 28 is held such that the upper face 28n of the shaft fixation portion 28a and the disk mounting face 28i each extend in a direction that is approximately orthogonal to the ultrasonic wave propagation direction D, and such that the upper face 28n, the clamp screw holes 34, and the disk mounting face 28i each face the back side of the ultrasonic wave generator.

The ultrasonic waves have relatively high frequency. Thus, such ultrasonic waves tend not to go around behind an obstacle, i.e., tend not to exhibit a so-called diffraction phenomenon. Thus, the workpiece is preferably cleaned with an orientation such that the surface of the workpiece to be cleaned at a high priority level faces the ultrasonic wave generator or such that it extends in a direction that is orthogonal to the ultrasonic wave propagation direction. With the orientation of the hub 28 shown in FIG. 9A according to the present embodiment, the ultrasonic waves can reach the upper face 28n of the hub 28, the disk mounting face 28i, the clamp screw holes 34, the shaft fixation portion 28a, and the lower face of the disk fitting portion 28b. In this case, only a small portion of the outer cylindrical face 28d is shadowed by the hub 28 itself with respect to the ultrasonic waves. Thus, overall, foreign substances that adhere to the hub 28 can be removed with high efficiency. With the orientation shown in FIG. 9B, the ultrasonic waves can reach the upper face 28n, the disk mounting face 28i, and the clamp screw holes 34, thereby providing these portions with higher level of cleanness. In a case in which foreign substances should be removed from the inner face of each clamp screw hole 34 at a high priority level, this orientation may be employed as a candidate. With the orientation shown in FIG. 9C, ultrasonic waves can reach the shaft fixation portion 28a and the lower face of the disk fitting portion 28b with high efficiency, thereby providing these portions with a higher level of cleanness. It should be noted that the orientation of the workpiece may be changed for each cleaning bath. Also, the orientation of the workpiece may be changed in the same cleaning bath. Also, multiple ultrasonic wave generators may be provided to multiple faces of the cleaning bath. For example, a pair of ultrasonic wave generators may be provided on the left face and the right face of the cleaning bath with respect to the workpiece transport direction.

Returning to FIG. 7, a cleaning liquid is jetted from a jet nozzle 422 into the third cleaning liquid 408, thereby generating a water flow in the third cleaning liquid 408. The water flow thus generated allows the removal of remaining foreign substances and foreign substances that have adhered to the workpiece again in the cleaning liquid.

In the drying step S205, the workpiece is dried. In the drying step S205, first, the hub 28 is held with an orientation such that the disk mounting face 28i faces upward. Next, hot air is blown onto the hub 28 while it is transported in a drying oven. The hot air is blown from the disk mounting face 28i side and the opposite side thereof. This allows the cleaning liquid to evaporate from the hub 28. It is needless to say that such an arrangement allows the cleaning liquid to evaporate from the inner space of each clamp screw hole 34. The temperature of the hot air and the hot air blowing time can be determined by experiment. After the drying step S205, the hub 28 is used as a component in the assembling step S210.

With the manufacturing method according to the present embodiment, the cleaning liquid penetrates into each hole formed in a workpiece. Specifically, such an arrangement allows the cleaning liquid to penetrate into each hole in a relatively short period of time on the order of 22 seconds. Subsequently, the workpiece in a state in which the cleaning agent has been charged into each hole is cleaned in the cleaning bath. Thus, such an arrangement allows ultrasonic waves and water flow to reach the inner space of each hole, thereby cleaning each hole. As a result, such an arrangement provides a required level of cleanness in a relatively short period of time. That is to say, even in a case in which a higher level of cleanness is required as compared with conventional processes, such an arrangement is capable of reducing foreign substances that adhere to each component while suppressing an increase in time required for the manufacturing of the rotating device.

With the manufacturing method according to the present embodiment, the bubbles floating in the charging liquid 302 can be removed. Such an arrangement is capable of preventing re-penetration into the workpiece holes of the air removed from the workpiece holes and the air generated from the charging liquid 302 due to decompression or application of ultrasonic waves.

Also, with the manufacturing method according to the present embodiment, the orientation of the workpiece is changed while maintaining a state in which the workpiece is dipped in the charging liquid 302. Thus, such an arrangement prevents the penetration of air into the workpiece holes due to the flowing-out of the charging liquid 302 from the workpiece holes when the orientation of the workpiece is changed.

Also, with the manufacturing method according to the present embodiment, the workpiece is transported from the liquid bath 304 to the first cleaning bath 410 without exposing the workpiece to air. Thus, such an arrangement prevents the penetration of air into the workpiece holes due to the flowing-out of the charging liquid 302 from the workpiece holes when the workpiece is transported.

Description has been made in the embodiment regarding a manufacturing method for a rotating device according to the embodiment. The above-described embodiments have been described for exemplary purposes only, and are by no means intended to be interpreted restrictively. Rather, it can be readily conceived by those skilled in this art that various modifications may be made by making various combinations of the aforementioned components, which are also encompassed in the technical scope of the present invention.

### [Modification 1]

Description has been made in the embodiment regarding an example in which the rotating device 100 configured as a hard disk drive is manufactured. However, the manufacturing target is not restricted to such a hard disk drive. For example, the technical idea according to the embodiment is applicable to a manufacturing method for manufacturing a desired kind of rotating device having components each of which is required to be cleaned in the manufacturing process in order to remove foreign substances.

[Modification 2] Description has been made in the embodiment regarding an example in which the hub 28 is formed by machining or the like. However, the manufacturing method is not limited to such a process. For example, the hub may be formed by plastic forming such as press forming. In this case, hydrocarbon dust derived from pressing oil that adheres to a pressing machine can migrate to the hub 28 after it has been formed, and such hydrocarbon dust can adhere to the hub 28 as a foreign substance. Thus, by cleaning the hub 28 in the same manner as in the embodiment, such an arrangement is capable of removing such an adhering foreign substance from the hub 28.

### [Modification 3]

The base 4 may be configured by making a combination of a base portion formed by pressing a metal plate such as an aluminum plate, an iron plate, or the like, and a die-cast portion formed of aluminum by die casting. For example, the bottom portion 4a may be configured including such a plate portion. Also, the outer wall portion 4b may be configured including such a die-cast portion. Such a configuration suppresses degradation of the rigidity of the screw hole 22. Examples of a method for manufacturing such a base 4 include a method whereby the die-cast portion is formed by means of aluminum die casting in a state in which such a plate portion formed beforehand is mounted on an aluminum die-cast base. Such a manufacturing method allows the bonding between the plate portion and the die-cast portion to be formed in a simpler manner. Furthermore, such a method allows the plate portion and the die-cast portion to have an improved size precision. Also, such a method allows an additional member for connecting the plate portion and the die-cast portion to be configured with a reduced size. Alternatively, such a method allows the plate portion and the die-cast portion to be connected without such an additional member. As a result, such an arrangement allows the base 4 to be configured to have a small thickness.

In a case of forming the base 4 as described above, hydrocarbon dust derived from materials used to manufacture the base 4 can migrate to the base 4 after it has been formed, and can adhere to the base 4 as a foreign substance. Thus, by performing the same cleaning processing as in the embodiment, such an arrangement is capable of removing such an adhering foreign substance from the base 4.

### [Modification 4]

Description has been made in the embodiment regarding an example in which the hub 28 is subjected to ultrasonic cleaning in a state in which it is dipped in the cleaning liquid. However, the present invention is not restricted to such an arrangement. Also, other kinds of cleaning methods such as shower cleaning may be employed.

### [Modification 5]

Description has been made in the embodiment regarding an arrangement in which, in the cleaning processing, three baths, i.e., the first cleaning bath 410, the second cleaning bath 412, and the third cleaning bath 414, are used. However, the present invention is not restricted to such an arrangement. Also, the cleaning processing may be performed using a single bath alone. Also, the cleaning processing may be performed using two baths or otherwise four or more baths.

### [Modification 6]

Description has been made in the embodiment regarding an arrangement in which, after the workpiece is formed, the workpiece configured as a single component is cleaned. However, the present invention is not restricted to such an arrangement. For example, a step in which the magnet 32 is mounted on the hub 28 may be provided between the hub 28 forming step S201 and the charging and cleaning step S202, or otherwise between the vibration processing and the cleaning processing in the charging and cleaning step S202. In a case in which the magnet 32 is fixed to the hub 28 by adhesion after the hub 28 is cleaned and dried, such a manufacturing method has the potential to lead to a problem of adhesion of an adhesive agent or grease and oil to the hub 28 and the magnet 32 from the hands of the operator or from the manufacturing equipment. In contrast, with the manufacturing method according to the present modification, the hub 28 is cleaned after the magnet 32 is mounted on the hub 28. Thus, such an arrangement is capable of reducing a quantity of an adhesive agent and a quantity of grease and oil that adhere when the magnet 32 is fixed to the hub 28 by adhesion.

Also, the hub 28 mounting the magnet 32 may be cleaned after the hub 28 is cleaned. In this case, the hub 28 mounting the magnet 32 is cleaned after the magnet 32 is mounted on the hub 28. Such an arrangement is capable of reducing, by means of cleaning, a quantity of adhesive agent and a quantity of grease and oil that adhere when the magnet 32 is fixed to the hub 28 by adhesion.

The same can be said of a combination of the base 4 and the stator core 40. That is to say, a step in which the stator core 40 is mounted on the base 4 may be provided between the base 4 forming step S201 and the charging and cleaning step S202, or otherwise between the vibration processing and the cleaning processing. Also, the base 4 mounting the stator core 40 may be cleaned after the base 4 is cleaned. In this case, the base 4 mounting the stator core 40 is dipped in the cleaning liquid and cleaned using ultrasonic waves.

### [Modification 7]

Description has been made in the embodiment regarding an arrangement in which the workpiece is dipped in an aqueous solution containing surface tension depressant in a decompression chamber in a charging and cleaning step S202. However, the present invention is not restricted to such an arrangement. For example, the workpiece may be dipped in such an aqueous solution in an atmospheric pressure environment. Also, in such a decompression chamber, the workpiece may be dipped in a liquid which can be substantially regarded as pure water.

### [Modification 8]

Description has been made in the embodiment regarding an arrangement in which, in the charging and cleaning step S202, the workpiece is dipped in a liquid so as to allow the liquid to be charged into each workpiece hole. However, the present invention is not restricted to such an example. Also, a nozzle may be inserted into each workpiece hole so as to discharge a liquid from the nozzle, thereby allowing the liquid to be charged into each workpiece hole. Also, a guide rod may be inserted into each workpiece hole so as to allow the liquid to flow into the workpiece hole via the guide rod. In these cases, the liquid may be configured as an aqueous solution containing a surface tension depressant in the same way as in the embodiment. Also, such processing may be performed in a reduced-pressure atmosphere.

### [Modification 9]

Description has been made in the embodiment regarding an arrangement in which, in the charging and cleaning step S202, the pressure is reduced in a state in which the workpiece is dipped in the charging liquid 302, thereby allowing the air to be removed from each workpiece hole, and allowing the first liquid to be charged into each workpiece hole. However, the present invention is not restricted to such an arrangement. For example, the workpiece may be dipped in the charging liquid 302 after the pressure is reduced so as to remove air from each workpiece hole, thereby allowing the charging liquid 302 to be charged into each workpiece hole.

What is claimed is:

1. A manufacturing method for a rotating device comprising a hub on which a recording disk is to be mounted and a base that rotatably supports the hub, wherein the manufacturing method comprises:
a charging and cleaning step comprising:
deaerating a hole formed in a workpiece configured as at least one from among the hub and the base;
charging a first liquid into the hole; and
dipping and cleaning the workpiece in a second liquid in a state in which the first liquid has charged into the hole of the workpiece; and
an assembling step for assembling the rotating device using the workpiece after the dipping and cleaning as a component.

2. The manufacturing method for a rotating device according to claim 1, wherein the first liquid has a lower surface tension than that of pure water.

3. The manufacturing method for a rotating device according to claim 1, wherein the first liquid is configured as an aqueous solution containing a surface tension depressant.

4. The manufacturing method for a rotating device according to claim 1, wherein the first liquid is configured as an aqueous solution containing a surfactant.

5. The manufacturing method for a rotating device according to claim 1, wherein the first liquid is configured as an aqueous solution containing a fluorochemical surfactant.

6. The manufacturing method for a rotating device according to claim 1, wherein the charging and cleaning step comprises checking a state of the hole formed in the workpiece after the charging.

7. The manufacturing method for a rotating device according to claim 1, wherein the charging and cleaning step comprises processing performed in a reduced-pressure atmosphere having a lower pressure than that of atmospheric pressure.

8. The manufacturing method for a rotating device according to claim 1, wherein the charging and cleaning step comprises dipping the workpiece in the first liquid in a reduced-pressure atmosphere having a pressure of 15 torr to 460 torr.

9. The manufacturing method for a rotating device according to claim 1, wherein the charging and cleaning step comprises changing an orientation of the workpiece in a state in which the workpiece is dipped in the first liquid.

10. The manufacturing method for a rotating device according to claim 1, wherein the workpiece has a first hole and a second hole formed along different directions,
and wherein the charging and cleaning step comprises changing the orientation of the workpiece dipped in the first liquid from a first orientation in which an opening of the first hole faces upward in a vertical direction to a second orientation in which an opening of the second hole faces upward in the vertical direction.

11. The manufacturing method for a rotating device according to claim 1, wherein the charging and cleaning step comprises removing bubbles suspended in the first liquid in a state in which the workpiece is dipped in the first liquid.

12. The manufacturing method for a rotating device according to claim 1, wherein the charging and cleaning step comprises dipping a container, which is accommodating the workpiece and the first liquid, in the second liquid.

13. A manufacturing method for a rotating device comprising a hub on which a recording disk is to be mounted and a base that rotatably supports the hub, wherein the manufacturing method comprises:
a charging and cleaning step comprising:
dipping a workpiece configured as at least one from among the hub and the base in the first liquid stored in a container, and dipping and cleaning the workpiece in a second liquid together with the container in a state in which the workpiece is dipped in the first liquid; and
an assembling step for assembling the rotating device using the workpiece after the dipping and cleaning as a component.

14. The manufacturing method for a rotating device according to claim 13, wherein the first liquid has a lower surface tension than that of pure water.

15. The manufacturing method for a rotating device according to claim 13, wherein the first liquid is configured as an aqueous solution containing a fluorochemical surfactant.

16. The manufacturing method for a rotating device according to claim 13, wherein the charging and cleaning step comprises processing performed in a reduced-pressure atmosphere having a lower pressure than that of atmospheric pressure.

17. The manufacturing method for a rotating device according to claim 13, wherein the charging and cleaning step comprises changing an orientation of the workpiece in a state in which the workpiece is dipped in the first liquid.

18. A manufacturing method for a rotating device comprising a hub on which a recording disk is to be mounted and a base that rotatably supports the hub, wherein the manufacturing method comprises:
a charging and cleaning step comprising:
charging a first liquid configured as an aqueous solution containing a fluorochemical surfactant into a hole formed in a workpiece configured as at least one from among the hub and the base in a reduced-pressure atmosphere having a lower pressure than that of atmospheric pressure, and dipping and cleaning the workpiece in a second liquid that differs from the first liquid in a state in which the first liquid has charged into the hole; and
an assembling step for assembling the rotating device using the workpiece after the dipping and cleaning as a component.

19. The manufacturing method for a rotating device according to claim 18, wherein the charging and cleaning step comprises changing an orientation of the workpiece in a state in which the workpiece is dipped in the first liquid.

20. The manufacturing method for a rotating device according to claim 18, wherein the charging and cleaning step comprises dipping a container, which is accommodating the workpiece and the first liquid, in the second liquid.
